(19) United States
(12) Patent Application Publication
(10) Pub. No.: US 2002/0171029 A1
(43) Pub. Date: Nov. 21, 2002

(54) TEM modes of nanowire arrays for use in photolithography

(75) Inventor: Peter A. Wolff, Boston, MA (US)

Correspondence Address: PHILIP J FEIG, NEC RESEARCH INSTITUTE INC, 4 INDEPENDENCE WAY, PRINCETON, NJ, 08540

(73) Assignee: NEC Research Institute, Inc., Princeton, NJ

(21) Appl. No.: 09/819,341

(22) Filed: Mar. 28, 2001

(51) Int. Cl. G02B 7/04

(52) U.S. Cl. 250/201.3

(57) ABSTRACT

A nanowire array supports axially-propagating TEM modes. The resolution of the array is determined by the interwire spacing rather than by the optical wavelength. The resolution can be made smaller than the optical wavelength. A bipartite honeycomb configuration is the preferred structure to support the TEM modes. Each nearest neighbor wire pair in the array (from opposite classes in a bipartite nanowire array) can be viewed as a two-wire transmission line, embedded in the surrounding matrix. Selective pairs of nanowires can be activated with wire loops, in a manner similar to that used to couple light to coaxes. The pattern of the wire loops determines where the array is excited; hence where light is transmitted. In effect, loop positioning provides a method of “writing” a desired transmission pattern into a pristine array in a similar manner as lithography.

### FIELD OF THE INVENTION

The present invention concerns TEM modes of nanowire arrays and particularly the use of such arrays in photolithography.

### BACKGROUND OF THE INVENTION

Near-field optical microscopy (NSOM) has been used to circumvent the limitation of conventional optical imagery systems. In NSOM, an aperture having a diameter smaller than an optical wavelength is disposed in close proximity to the specimen surface and scanned over the surface.

In recent approaches to near-field scanning optical microscopy the light is transmitted through a metal coated optical fiber, whose end opposite the specimen is drawn down to produce a small diameter (order of 50 nm) centrally disposed aperture. The resulting structure is essentially a tapered wave guide that reflects almost all light as its diameter becomes smaller than the optical wavelength. Consequently, in tips with small apertures the signal levels are very low.

Moreover, if the aperture is enlarged to permit more light to pass, the resolution is reduced, obviating any advantage of using near-field scanning optical microscopy instead of conventional optical microscopy.

In order to maintain the transmission efficiency without unduly reducing the resolution, U.S. Pat. No. 5,789,742 entitled “Near-Field Scanning Optical Microscope Probe Exhibiting Resonant Plasmon Excitation” having inventor Peter A. Wolff, discloses a tapered probe for use in near-field scanning optical microscopy coated with a sheath of metal material having a plasma frequency comparable to optical frequencies.

Tapered, coaxial, optical wave guide structures are desirable for use in NSOMs because these waveguides are capable of supporting optical waves, without cutoff, at all frequencies. Coaxial structures are described in the book “Time Harmonic Electromagentic Fields” by R. F. Harrington, McGraw-Hill, New York 1961.

U. Ch. Fischer and M. Zapletal in an article in Ultramicroscopy, 42-44, page 393 (1992) and U.S. Pat. No. 4,994,818 entitled “Scanning Tip for Optical Radiation” by F. Keilman describe fabrication of coaxial NSOM tips.

In the future, there will be a need for bundles of tapered coaxial waveguides for viewing larger images. Fabrication of such bundles of glass-pulled, NSOM tips will be difficult, but suitable nanowire arrays embedded in transparent dielectrics may equally well accomplish the goals. Such tips can support propagating TEM modes over large areas, and could be very useful in lithography.

The present invention concerns improved optical structures that increase NSOM resolution and improve optical throughput.

The present invention also concerns the use of nanowire arrays as separately addressable, two-wire transmission lines whose resolution is determined by wire spacing rather than by the optical wavelength. Furthermore, as is known to those skilled in the art, such transmission lines support propagating TEM modes at all frequencies.

### SUMMARY OF THE INVENTION

Nanowire arrays are fabricated in accordance with several methods. One well-known, simple method uses solution chemistry and electrolysis to generate triangular pore arrays in aluminum oxide films, which pores are subsequently filled with metal. See, for example, K. Itaya et al in the Journal of Chemistry Engineering Japan, 17, page 515, (1984). An article of Z. Zhang et al in the Journal of Materials Research, volume 13, page 1745 (1998), for example, describes the use of a method to grow nearly perfect Bi nanowire arrays, with a period of 50 nm and wire diameters of 13 nm. In these arrays, the wire spacing is one tenth of a typical optical wavelength.

The process is rugged and flexible; nanowire arrays of several metals have been fabricated by the method. In another method, described by R. J. Tonucci et al in Science, volume 258, page 783 (1992), nanochannel glass arrays are filed with metals to create nanowire arrays.

A principal object of the present invention is therefore, the provision of a nanowire array capable of supporting TEM modes of light propagating therethrough.

Another object of the present invention is the provision of a nanowire array useful as separately addressable, two-wire transmission lines whose resolution is determined by wire spacing rather than by the optical wavelength.

A further object of the invention is the provision of a nanowire array capable of supporting TEM modes of light propagating therethrough over a large area.

A still further object of the invention is the provision of a nanowire array capable of supporting TEM mode of light propagating therethrough for use in photolithography.

Further and still other objects of the invention will become more clearly understood when the following description is read in conjunction with the accompanying drawing.

### BRIEF DESCRIPTION OF THE DRAWINGS

FIG. 1 is a nanowire array in a honeycomb configuration;

FIG. 2 is an illustration of field lines and equipotentials of an embodiment of symmetrical TEM modes of a honeycomb array;

FIG. 3A is a schematic representation of a model six-wire approximation to a nanowire array comprising a loop-coupled-pair in addition to other near-neighbors.

FIG. 3B is a schematic representation of an alternative model six-wire approximation to a nanowire array comprising a loop-coupled-pair in addition to other near-neighbors.

FIG. 4 is an alternative nanowire configuration, better approximating an array of transmission lines.

FIG. 5 is a preferred embodiment of the invention useful for etching a pattern in photoresist.

### DETAILED DESCRIPTION OF THE INVENTION

In the description above, several well-known methods of fabricating nanowire arrays are described. The TEM solution of Maxwell's equations for waves propagating parallel to the nanowire axes (in the z-direction) in the nanowires is derived as follows. The TM condition, H_{z}=0, implies

$$0 = {( ∇ \times \vec{E} )}_{z} = ( \frac{\partial Ey}{\partial x} - \frac{\partial Ex}{\partial y} ) = - ∇ V [ x , y ] x Exp [ i β z ] ,$$

where β is the propagation constant in the z-direction common to all fields and V will later be seen to be the potential of the TEM mode. Since there are no charges in the dielectric, 0=Div(\vec{E})=−∇²V[x, y]+iβz. Thus, E_{z}=0 for a TEM mode implies ∇²V=0 (Laplace's equation) a well-known result requiring a non-zero solution of Laplace's equation for TEM mode to exist. See, O. M. Gandhi, Microwave Engineering and Applications, (Pergamon Press, New York, 1981).

There are probably many such modes in multi-conductor nanowire arrays whose classification remains an open problem. Consideration will be given only to those modes of high symmetry that can best be excited by optical fields.

Having E determined by \vec{∇} V and the condition E_{z}=0, it is straightforward to calculate Hₓ and H_{y} from Maxwell's equation,

$$∇ \times \vec{E} = \frac{iw}{c} H .$$

The result is

$${H}_{x} = ( \frac{β c}{ω} ) \frac{\partial V}{\partial y} and {H}_{y} = - ( \frac{β c}{ω} ) \frac{\partial V}{\partial x} .$$

Note that \vec{E} and \vec{H} are transverse and orthogonal to one another. Finally, by substituting all fields into either Maxwell equation, one obtains the consistency equation

$${β}^{2} = ( \frac{{ω}^{2} ϵ}{{c}^{2}} ) ,$$

showing that the TEM waves travel at the velocity of light in the dielectric at all frequencies.

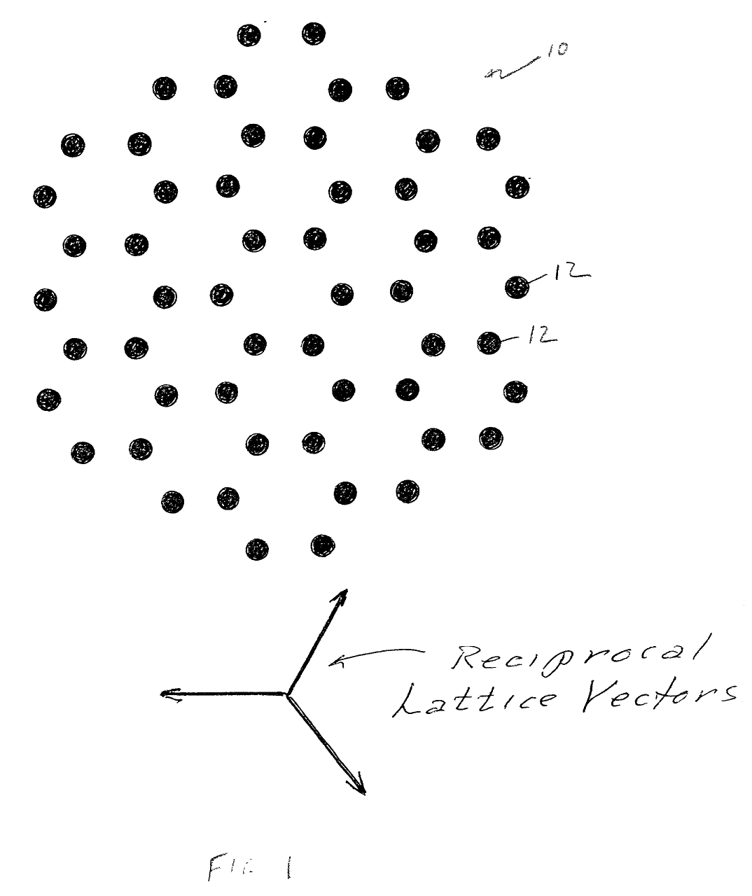

Referring now to the figures and to FIG. 1 in particular, there is shown a honeycomb nanowire array 10. The simplest realization of TEM modes are those in nanowave arrays in the honeycomb lattice, because in this bipartite geometry the wires 12 are in two classes, with wires of a given class having only nearest neighbors of the opposite class. In this situation it seems clear, on physical grounds, that there is a non-zero solution of Laplace's equation describing the potential between wires when those of one class are charged to voltage +V, with those of the other class charged to voltage −V.

To further test this concept, there was constructed an approximate potential by combining waves having the three reciprocal lattice vectors shown in FIG. 1 of the form

$${\sum }_{i = 1}^{3} [ sin ( {\vec{k}}_{i} \cdot \vec{r} + ϕ ] ,$$

with phase factors chosen to make each term in the sum vanish at the mid-point between wires. Here r=0 is at a wire. By expanding in powers of r about this origin, one finds that this simple approximation makes the nanowires equipotentials to order (r/a)² where “a” is the lattice constant of the array. The first approximation could be improved with more reciprocal lattice vectors

To my knowledge, no one has yet created a honeycomb nanowire array, although it is conceived to do so from nanochannel glass. Alternates to aluminum oxide for membranes might also be found.

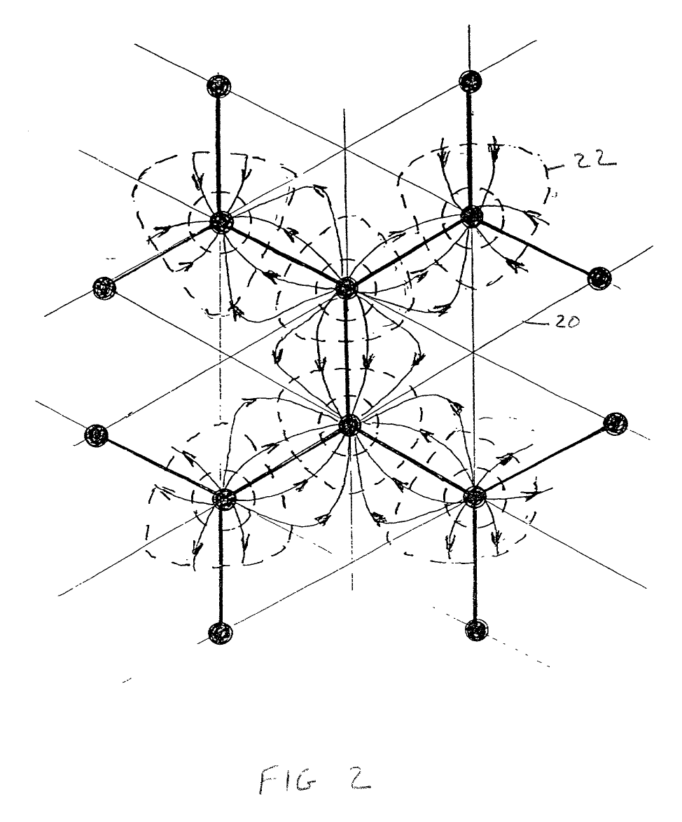

FIG. 2 illustrates field lines(solid lines) and equipotentials (dashed lines) of the proposed, symmetrical TEM mode of the honeycomb array structure for the case in which the wire radii are small compared to their spacing. In an article by Zhang et al in Journal of Material Research, volume 13, page 1745 (1998), it is reported that such samples (with Bi-wire diameters of 13 nm) are almost transparent to light in the wavelength range of 300-1800 nm. FIG. 2 shows that the TEM mode has a field distribution, resembling that of a transmission line in between every nearest neighbor pair of wires. This observation helped motivate the invention.

Having demonstrated the possible existence of propagating TEM modes in honeycomb nanowire arrays, next consider their use in lithography. For this purpose it is important to understand how light couples to such structures. In a first approximation, the TEM mode of a perfect nanowire array is not expected to be effectively excited by optical plane waves because, in normal incidence, their polarization is then orthogonal to the longitudinal (z-directed) wire currents supporting the TEM mode. A similar problem is encountered in coupling radiation to the TEM mode of a coaxial cable—whose mode is also supported by z-directed currents. This problem can be solved fairly simply, however, by connecting the inner and outer conductors of the coaxial cable by a wire loop normal to the magnetic field of the incident optical wave (see Gandhi, supra.) The oscillating field then excites oppositely directed currents in the two conductors, thereby exciting the TEM mode. A similar strategy will now be described in connection with Honeycomb nanowire arrays. In such arrays each nearest neighbor pair (necessarily belonging to opposite bipartite classes of the array) can be viewed as a two-wire transmission line embedded in the surrounding matrix. As is known to those skilled in the art, such pairs support a localized, propagating TEM mode. These localized TEM modes are selectively excited by activating the desired pairs with wire loops, in a manner similar to that used to couple light to coaxial structures. The pattern of loops then determines where the array is excited; hence, where the array transmits light. In effect, loop positioning is one way to “write” a desired transmission pattern into a pristine array. In the absence of coupling to the surrounding matrix, the pair's TEM mode is concentrated between the pairs (see FIG. 2), with a spot size comparable to the pair spacing. Pair-matrix coupling will cause a less-confined background of lower intensity than this focus, but there still should be an enhanced optical field intensity between the pairs that could be used for lithography. A simple calculation (shown below) for a six-wire model problem suggests that mode amplitude cancellation will, in fact, diminish the background due to pair-matrix interactions.

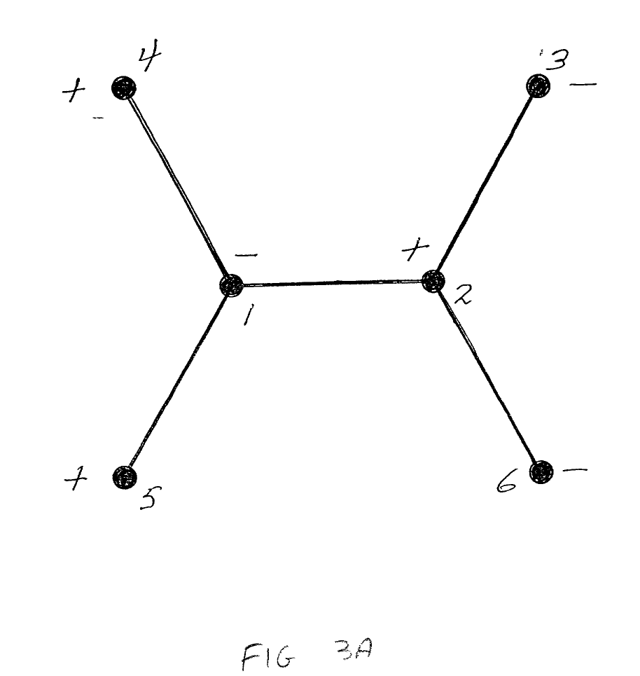

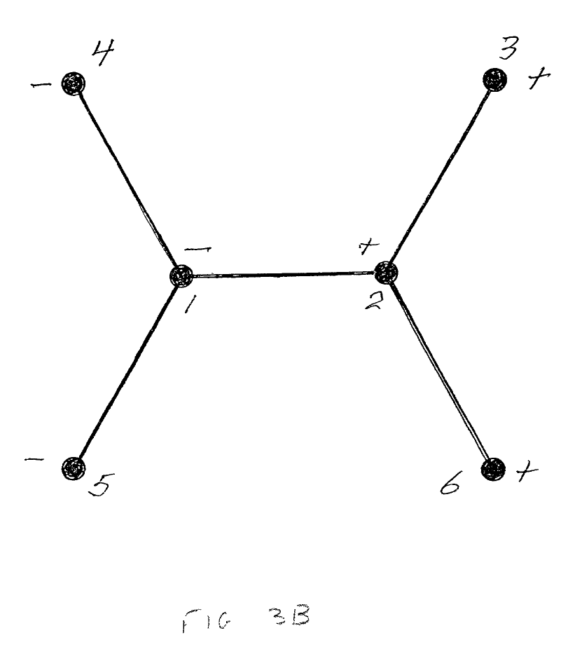

In order to estimate this effect, consider the 2-dimension TEM potential, V(x, y), for a model six-wire problem comprising the loop-coupled-pair in addition to the other near-neighbors, as shown in FIGS. 3A and 3B. This structure supports two modes (antisymmetric with respect to the reflection plane normal to the figure) that could be excited by applied electric fields between sites 1 and 2. Their approximate potentials, in the limit of small nanowire radius, are

V_{A}(x,y)=½{ln[(\vec{r}−\vec{r}₁)²(\vec{r}−\vec{r}₃)²(\vec{r}−\vec{r}₄)²]−ln[(\vec{r}−\vec{r}₂)²(\vec{r}−\vec{r}₅)²(\vec{r}−\vec{r}₆)²]}

and

V_{B}(x,y)=½{ln[(\vec{r}−\vec{r}₁)²(\vec{r}−\vec{r}₅)²(\vec{r}−\vec{r}₆)²]−ln[(\vec{r}−\vec{r}₂)²(\vec{r}−\vec{r}₃)²(\vec{r}−\vec{r}₄)²]}

that can easily be evaluated to determine relative nanowire potentials. In both cases, the potentials of the peripheral wires are comparable in magnitude to those of wires 1 and 2. Thus, neither mode is well-localized. However, when both wires are excited by fields between sites 1 and 2, the peripheral sites acquire voltages with opposite phases. When the cancellation is substantial, the excited pair could truly behave as a TEM, two-wire transmission line for lithography.

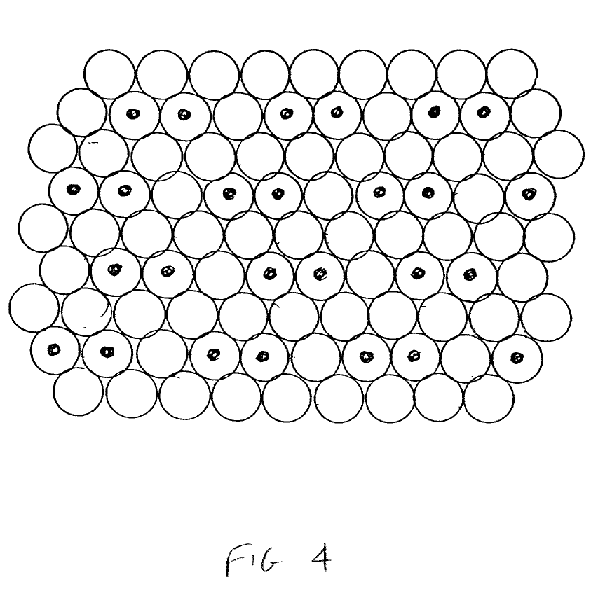

FIG. 4 shows another nanowire geometry which could better reduce the coupling of neighboring wires to the driven pair, although at some cost in resolution. Such structures could be fabricated in glass nanochannel arrays. See, R. J. Tonucci et al, Science, volume 258, page 783 (1992).

It will be noted that in either of the two nanochannel array-types described above, the pattern of optical excitation is determinable by the positions of the activated nanowire pairs, via wire-loops or by other means. This characteristic provides an ability to “write” into a nanowire array the pattern required for a specific device implementation simply by controlling the position of pair activation. In effect, the nanowire array will be a medium in which optical resolution is determined by pair spacing rather than by diffraction. In high resolution lithography applications using nanowire arrays, the specimen to be patterned must be located in the near field.

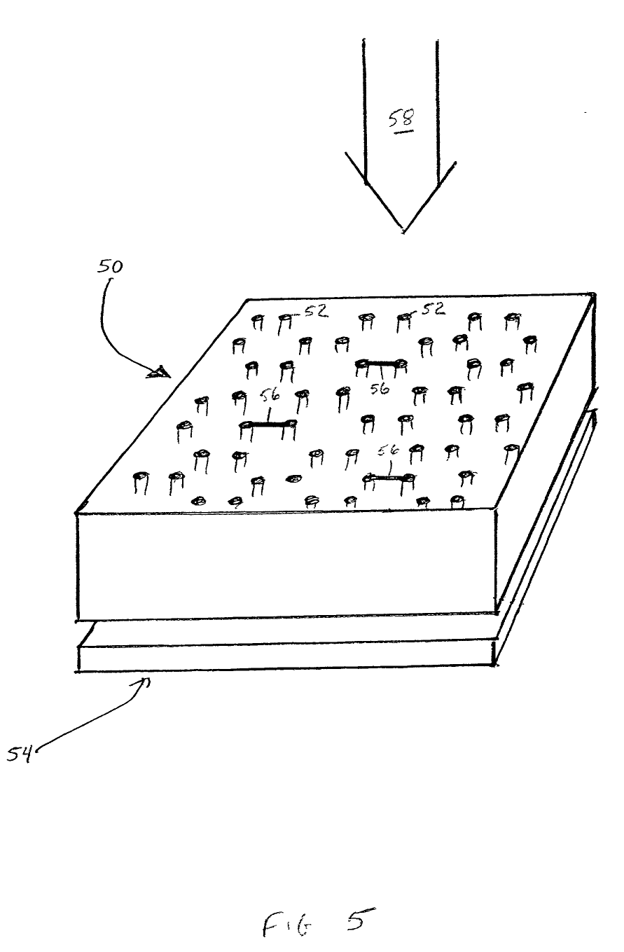

Referring now to FIG. 5, there is shown a preferred embodiment of the use of TEM modes in nanowire arrays to etch a pattern into photoresist, passing through the patterned nanowire array.

A two-dimension nanowire array 50 of nanowires 52 is placed in superposition with a layer of photoresist 54. Nearest neighbor pairs of nanowires are coupled in a predetermined pattern using wire loops 56. In accordance with the teachings above, pairs of adjacent nanowires are excited by light 58 in a predetermined pattern. The result is that the photoresist in the immediate region of the excited pair of nanowires is etched in the predetermined pattern.

While there has been described and illustrated TEM modes of nanowire arrays, particularly for use in photolithography, it will be apparent to those skilled in the art that further variations and modifications are possible without deviating from the spirit and broad teachings of the invention which shall be limited solely by the scope of the claims appended hereto.

What is claimed is:

1. A nanowire array for axially-propagating TEM modes comprising:
a nanowire array of nanowires in two classes, where nanowires of a first class have only nearest neighbors of a second class;
where said nanowires in said first class are charged to a predetermined voltage of a first polarity and said nanowires in said second class are charged to a predetermined voltage of an opposite polarity, where the predetermined voltages are substantially the same at both polarities.

2. A nanowire array as set forth in claim 1, where said nanowires are disposed in a honeycomb lattice configuration.

3. A nanowire array for axially-propagating TEM modes useful in lithography comprising:
a nanowire array of nanowires in two classes, where nanowires of a first class have only nearest neighbors of a second class;
where said nanowires in said first class are charged to a predetermined voltage of a first polarity and said nanowires in said second class are charged to a predetermined voltage of an opposite polarity, where the predetermined voltages are substantially the same at both polarities; and
coupling a nearest neighbor pair of nanowires, where the nanowires of the pair belong to opposite bipartite classes of the array.

4. A nanowire array as set forth in claim 3, further comprising a wire loop for coupling a nearest neighbor pair of nanowires.

5. A nanowire array as set forth in claim 3, where said nanowires are disposed in a honeycomb lattice configuration.

6. A nanowire array as set forth in claim 5, further comprising a wire loop for coupling a nearest neighbor pair of nanowires.

7. A nanowire array as set forth in claim 3, further comprising photoresist disposed between said nanowire array and a specimen so that when said nanowire array is exposed to light, said photoresist will be etched in said photoresist at a location corresponding to the location in the array where there is the coupled pair of nanowires.

8. A nanowire array as set forth in claim 7, further comprising a wire loop for coupling a nearest neighbor pair of nanowires.

9. A nanowire array as set forth in claim 7, where said nanowires are disposed in a honeycomb lattice configuration.

10. A nanowire array as set forth in claim 9, further comprising a wire loop for coupling a nearest neighbor pair of nanowires.

11. A nanowire array as set forth in claim 3, where a plurality of pairs of nearest neighbor nanowires are coupled in a predetermined pattern and where said photoresist will be etched in a pattern corresponding to the pattern of coupled nanowire pairs in the nanowire array.

12. A nanowire array as set forth in claim 11, further comprising a plurality of wire loops for coupling a nearest neighbor pairs of nanowires.

13. A nanowire array as set forth in claim 11, where said nanowires are disposed in a honeycomb lattice configuration.

14. A nanowire array as set forth in claim 13, further comprising a plurality of wire loops for coupling a nearest neighbor pairs of nanowires.

15. A photolithography apparatus comprising:
a light source;
a nanowire array of nanowires in two classes, where nanowires of a first class have only nearest neighbors of a second class;
where said nanowires in said first class are charged to a predetermined voltage of a first polarity and said nanowires in said second class are charged to a predetermined voltage of an opposite polarity, where the predetermined voltages are substantially the same at both polarities;
coupling a nearest neighbor pair of nanowires, where the nanowires of the pair belong to opposite bipartite classes of the array;
photoresist disposed between said nanowire array and a specimen so that when said nanowire array is exposed to light, said photoresist will be etched in said photoresist at a location corresponding to the location in the array where there is the coupled pair of nanowires.

16. A photolithography apparatus as set forth in claim 15, further comprising a wire loop for coupling a nearest neighbor pair of nanowires.

17. A photolithography apparatus as set forth in claim 15, where said nanowires are disposed in a honeycomb lattice configuration.

18. A photolithography apparatus as set forth in claim 17 further comprising a wire loop for coupling a nearest neighbor pair of nanowires.

19. A photolithography apparatus as set forth in claim 9, where a plurality of pairs of nearest neighbor nanowires are coupled in a predetermined pattern and where said photoresist will be etched in a pattern corresponding to the pattern of coupled nanowire pairs in the nanowire array.

20. A photolithography apparatus as set forth in claim 19, further comprising a plurality of wire loops for coupling a nearest neighbor pairs of nanowires.

21. A photolithography apparatus as set forth in claim 19, where said nanowires are disposed in a honeycomb lattice configuration.

22. A photolithography apparatus as set forth in claim 21, further comprising a plurality of wire loops for coupling a nearest neighbor pair of nanowires.

23. A method of performing lithography comprising the steps of:
providing a nanowire array of nanowires in two classes, where nanowires of a first class have only nearest neighbors of a second class;
where said nanowires in said first class are charged to a predetermined voltage of a first polarity and said nanowires in said second class are charged to a predetermined voltage of an opposite polarity, where the predetermined voltages are substantially the same at both polarities;
coupling a nearest neighbor pair of nanowires, where the nanowires of the pair belong to opposite bipartite classes of the array;
disposing photoresist in proximity to said nanowire array;
illuminating said nanowire array with light for causing the photoresist to be etched at a location corresponding to the location of the in the array where there is the coupled pair of nanowires.

24. A method of performing photolithography as set forth in claim 23, where said coupling comprises using a wire loop for coupling a nearest neighbor pair of nanowires.

25. A method of performing lithography as set forth in claim 24, where said nanowires are disposed in a honeycomb lattice configuration.

26. A method of performing photolithography as set forth in claim 25, where said coupling comprises using a wire loop for coupling a nearest neighbor pair of nanowires.

27. A method of performing lithography as set forth in claim 23, further comprising coupling a plurality of pairs of nearest neighbor nanowires in a predetermined pattern and where said photoresist is etched in a pattern corresponding to the pattern of coupled nanowire pairs in the nanowire array.

28. A method of performing photolithography as set forth in claim 27, where said coupling comprises using a plurality of wire loops for coupling nearest neighbor pairs of nanowires.

29. A method of performing lithography as set forth in claim 28, where said nanowires are disposed in a honeycomb lattice configuration

30. A method of performing photolithography as set forth in claim 27, where said coupling comprises using a plurality of wire loops for coupling nearest neighbor pairs of nanowires.
